(19) United States
(12) Patent Application Publication
(10) Pub. No.: US 2026/0037843 A1
(43) Pub. Date: Feb. 5, 2026

(54) MULTI-AGENT TASK ALLOCATION METHOD BASED ON FUZZY INFERENCE

(71) Applicant: Shanghai University, Shanghai (CN)

(72) Inventors: Shaorong Xie, Shanghai (CN); Xiangfeng Luo, Shanghai (CN); Xinzhi Wang, Shanghai (CN); Mengke Wang, Shanghai (CN)

(21) Appl. No.: 19/067,119

(22) Filed: Feb. 28, 2025

(30) Foreign Application Priority Data
Jul. 30, 2024 (CN) 202411036396.5

(51) Int. Cl. G06N 5/048; G06N 5/043

(52) U.S. Cl. CPC G06N 5/048; G06N 5/043

(57) ABSTRACT

Provide is a multi-agent task allocation method based on fuzzy inference, which includes: obtaining multidimensional features of all agents at a historical moment and multidimensional features of all sub-tasks at the historical moment, and determining a sub-task selector network based on fuzzy inference according to mean values and covariances of all sub-tasks; with a goal of minimizing a first Temporal Difference (TD) loss function, training the sub-task selector network based on fuzzy inference and a sub-task policy network by utilizing a sub-task evaluation network; with a goal of minimizing a second TD loss function, training an agent policy network by utilizing an agent credit allocation network; sequentially inputting locally-observed information of each agent at a current moment, an execution action at a previous moment, and a sub-task at the previous moment into a trained agent policy network and a trained sub-task selector network based on fuzzy inference for sub-task allocation.

### CROSS REFERENCE TO RELATED APPLICATION

This patent application claims the benefit and priority of Chinese Patent Application No. 2024110363965, filed with the China National Intellectual Property Administration on Jul. 30, 2024, the disclosure of which is incorporated by reference herein in its entirety as part of the present application.

### TECHNICAL FIELD

This application relates to the field of multi-agent reinforcement learning, and in particular, relates to a multi-agent task allocation method based on fuzzy inference.

### BACKGROUND

As a next-generation artificial intelligence development plan is proposed, an autonomous intelligent system becomes a developmental focus of artificial intelligence, and a task executed by an agent changes from a simple static task to a complex dynamic task, for example, a complex task like a mountain target searching task. Compared with a single agent, a multi-agent has stronger advantages while executing a complex task, and therefore, is widely developed in the civil and military fields. The existing multi-agent reinforcement learning method can have good performance in most of cooperative tasks. However, in a more complex cooperative task scenario and under a flexible task need, it is difficult for the existing multi-agent reinforcement learning method to quickly and accurately allocate a functionally-adaptive sub-task to an agent due to increase of overall complexity of a cooperative task.

To resolve the problem and apply human prior knowledge to a task allocation process better, some multi-agent cooperative policy learning methods based on pre-definition, offline learning, and imitative learning are proposed. Research on a multi-agent reinforcement learning method based on value function decomposition is most extensive. To resolve the problem that it is difficult to directly learn a coalition policy under a dynamic environment change and a flexible task need, multi-agent reinforcement learning based on task decomposition and allocation is proposed. In these methods, a complex task is decomposed into a plurality of sub-tasks, distributed agents are combined into a multi-agent through task allocation, and the sub-tasks are allocated to one or more agents for execution, so that a given task goal is accomplished cooperatively.

However, most of existing task decomposition and allocation methods based on value decomposition usually depend on limited information, and factors such as a capability, a type, and a responsibility of each agent cannot be comprehensively considered, and consequently, task allocation cannot be quickly and accurately achieved. In addition, these methods are bottom-to-top task selection processes, and there are no top-to-bottom task allocation optimization and update processes, and consequently, a plurality of agents may competitively execute a same sub-task. This leads to a problem of low task allocation efficiency.

### SUMMARY

An objective of this application is to provide a multi-agent task allocation method based on fuzzy inference, a system, and a medium, to improve efficiency and an accuracy rate of multi-agent task allocation.

To achieve the above objective, this application provides the following technical solutions.

According to a first aspect, this application provides a multi-agent task allocation method based on fuzzy inference. The multi-agent task allocation method based on fuzzy inference includes the following steps:
determining a cooperative task scenario of an agent team, where the agent team includes a plurality of agents, and a plurality of sub-tasks are assigned in the cooperative task scenario;
performing adaptive decomposition on the cooperative task scenario by utilizing a Gaussian fitting process, determining a mean value and a covariance of each sub-task, and updating the mean value and the covariance of each sub-task online;
obtaining multidimensional features of all agents at a historical moment and multidimensional features of all sub-tasks at the historical moment, and determining a sub-task selector network based on fuzzy inference according to mean values and covariances of all sub-tasks, where the multidimensional feature includes an action sequence, a historical trajectory, and a contribution value;
constructing a dual-time-scale layered cooperative architecture, where a top layer of the layered cooperative architecture includes the sub-task selector network based on fuzzy inference, a sub-task evaluation network, and a plurality of sub-task policy networks; a bottom layer of the layered cooperative architecture includes an agent credit allocation network and an agent policy network; the sub-task evaluation network is configured to: evaluate an execution progress of each sub-task and determine a total task value; the total task value represents an execution progress in the cooperative task scenario, and the sub-task policy network is configured to determine a multidimensional feature of a sub-task; the agent credit allocation network is configured to: evaluate contribution of each agent on the agent team, and determine a team value; the team value represents overall efficiency of the agent team in the cooperative task scenario, and the agent policy network is configured to determine a multidimensional feature and an action value of the agent;
with a goal of minimizing a first Temporal Difference (TD) loss function, training the sub-task selector network based on fuzzy inference and the sub-task policy network by utilizing the sub-task evaluation network, where an intrinsic reward of the sub-task and an accumulative environment reward are added into the first TD loss function;
with a goal of minimizing a second TD loss function, training the agent policy network by utilizing the agent credit allocation network;
inputting locally-observed information of each agent at a current moment, an execution action at a previous moment, and a sub-task at the previous moment into a trained agent policy network to update a multidimensional feature of each agent, where the locally-observed information includes at least a location and a speed of a current agent, and a location and a speed of another agent within an observation range of the current agent; and
inputting an updated multidimensional feature of each agent into a trained sub-task selector network based on fuzzy inference for sub-task allocation.

Optionally, the performing adaptive decomposition on the cooperative task scenario by utilizing a Gaussian fitting process, determining a mean value and a covariance of each sub-task, and updating the mean value and the covariance of each sub-task online specifically includes:
obtaining a group of supervised offline data set, where the offline data set includes a historical trajectory of an agent for executing each sub-task, and an environment reward of each agent;
obtaining a reward function of each sub-task through Gaussian fitting by using the historical trajectory of the agent for executing each sub-task as an input and using the environment reward of each agent as an output;
determining the mean value and the covariance of each sub-task based on the reward function; and
updating the mean value and the covariance of each sub-task online by utilizing a negative log likelihood function.

Optionally, the obtaining multidimensional features of all agents at a historical moment and multidimensional features of all sub-tasks at the historical moment, and determining a sub-task selector network based on fuzzy inference according to mean values and covariances of all sub-tasks specifically includes:
defining a base rule of a Takagi-Sugeno-Kang (TSK) form;
under the base rule, taking each sub-task as a fuzzy set, and constructing a Gaussian membership function under each fuzzy set based on the multidimensional feature of each agent at the historical moment, the multidimensional feature of each sub-task at the historical moment, and the mean value and the covariance of each sub-task;
adjusting the base rule according to the Gaussian membership functions under all fuzzy sets to obtain a fuzzy inference rule for the cooperative task scenario; and
applying the fuzzy inference rule to the sub-task selector network to obtain the sub-task selector network based on fuzzy inference, where the sub-task selector network includes a fully-connected layer, a fuzzy inference layer, and a normalization layer that are sequentially connected.

Optionally, the first TD loss function is:

$${ℒ}_{ϕ} ( {θ}_{ϕ} , {ξ}_{ϕ} , {ε}_{ϕ} ) = {E}_{{D}^{h}} [ {( {R}_{T} + γ max {\overline{Q}}_{ϕ}^{tot} ( {s}_{T + 1} , {ϕ}_{T + 1} ) - {Q}_{ϕ}^{tot} ( {s}_{T} , {ϕ}_{T} ) )}^{2} ] ;$$

$${R}_{T} = {r}^{i n t} + {\sum }_{t = 1}^{{δ}_{c}} {r}_{t}^{e} ,$$

where

[symbol] _{ϕ}(·) is a first TD loss, θ_{ϕ} is a parameter of the sub-task policy network, ξ_{ϕ} is a parameter of the sub-task evaluation network, ε_{ϕ} is a parameter of the sub-task selector network based on fuzzy inference, [symbol] is an expected value of a top-layer accumulative reward of the layered cooperative architecture, R_{T} is a multi-step accumulative reward of the sub-task, γ is a discount factor,

$${\overline{Q}}_{ϕ}^{tot}$$

is a target total task value of the sub-task evaluation network,

$${Q}_{ϕ}^{tot}$$

is an actual total task value of the sub-task evaluation network, s_{T} is global environment information at a moment T, ϕ_{T} is a sub-task executed by all agents at the moment T, r^{int} is an intrinsic reward of the sub-task

$${r}_{t}^{e}$$

is an environment reward at a moment t, and δ_{c} is a sub-task selection frequency, where T>t.

Optionally, the second TD loss function is:

$${ℒ}_{a} ( {θ}_{a} , {ξ}_{a} ) = {E}_{{D}^{l}} [ {( {r}_{t}^{e} + γ max {\overline{Q}}_{a}^{tot} ( {s}_{t + 1} , {u}_{t + 1} ) - {Q}_{a}^{tot} ( {s}_{t} , {u}_{t} ) )}^{2} ] ,$$

where

[symbol] ₐ(·) is a second TD loss, θₐ is a parameter of the agent policy network, ξₐ is a parameter of the agent credit allocation network, [symbol] is an expected value of a bottom-layer accumulative reward of the layered cooperative architecture,

$${r}_{t}^{e}$$

is an environment reward at a moment t, γ is a discount factor,

$${\overline{Q}}_{a}^{tot}$$

is a target team value of the agent credit allocation network,

$${Q}_{a}^{tot}$$

is an actual team value of the agent credit allocation network, sₜ is locally-observed information of all agents at the moment t, and uₜ is an execution action of all agents at the moment t.

Optionally, the sub-task policy network includes a fully-connected layer, a recurrent layer, and a fully-connected layer that are sequentially connected, and the sub-task evaluation network is a hybrid network in a QMIX algorithm.

Optionally, the agent policy network and the agent credit allocation network are respectively a policy network and a hybrid network in a Value-Decomposition Networks (VDN) algorithm.

Optionally, the layered cooperative architecture further includes a top-layer experience pool and a bottom-layer experience pool.

The top-layer experience tool is configured to store a first data tuple at different moments, where the first data tuple includes at least: global environment information, an identity (ID) of a sub-task executed by all agents, and a multi-step accumulative reward of all sub-tasks. The global environment information includes at least: types, locations, and speeds of all agents, and a type and a location of an environment entity. The multi-step accumulative reward includes the intrinsic reward of the sub-task and the accumulative environment reward.

The bottom-layer experience tool is configured to store a second data tuple at different moments, where the second data tuple includes at least locally-observed information of each agent, an execution action, and an environment reward.

According to a second aspect, this application further provides a computer system, including a memory, a processor, and a computer program stored in the memory and executable on the processor, where the processor executes the computer program to perform the steps of the multi-agent task allocation method based on fuzzy inference.

According to a third aspect, this application further provides a computer-readable storage medium storing a computer program. When the computer program is executed by a processor, the multi-agent task allocation method based on fuzzy inference is implemented.

According to specific embodiments provided in this application, this application discloses the following technical effects:

In this application, in the cooperative task scenario of the plurality of agents, adaptive decomposition is performed by using the Gaussian fitting process to obtain the mean value and the variance of each sub-task. On this basis, the action sequence, the historical trajectory, and the contribution value of the agent are combined to form a unique multidimensional feature of the agent; and the sub-task selector network based on fuzzy inference is jointly designed and constructed, and dynamic and accurate sub-task allocation is implemented through the network. In addition, through a training manner in which another network in the layered cooperative architecture is trained, based on the sub-task evaluation network and the agent credit allocation network, with a goal of minimizing a temporal difference (TD) loss function, a sub-task allocation process of the agent adapts to a dynamic change of an environment and a task need more effectively. Finally, in the dual-time-scale layered cooperative architecture constructed in this application, a sub-task allocation result based on global consideration can be formed on the top layer, and the sub-task allocation result is input into the bottom layer for agent decision-making. Therefore, efficiency and an accuracy rate of multi-agent task allocation are improved in this application.

### BRIEF DESCRIPTION OF THE DRAWINGS

To describe the technical solutions in the examples of this application or in the prior art more clearly, the following briefly describes the accompanying drawings required for the examples. Apparently, the accompanying drawings in the following description show merely some examples of this application, and a person of ordinary skill in the art may still derive other accompanying drawings from these accompanying drawings without creative efforts.

FIG. 1 is a flowchart of a multi-agent task allocation method based on fuzzy inference to an embodiment of this application;

FIG. 2 is a diagram of an internal structure of a dual-time-scale layered cooperative architecture according to an embodiment of this application; and

FIG. 3 is a schematic diagram of a structure of a computer system according to an embodiment of this application.

### DETAILED DESCRIPTION OF THE EMBODIMENTS

The technical solutions in the embodiments of this application are clearly and completely described below with reference to the drawings in the embodiments of this application. Apparently, the described embodiments are only some rather than all of the embodiments of this application. All other embodiments obtained by a person of ordinary skill in the art based on the embodiments of this application without creative efforts shall fall within the protection scope of this application.

An objective of this application is to provide a multi-agent task allocation method based on fuzzy inference, a system and a medium, to improve efficiency and an accuracy rate of multi-agent task allocation.

To make the above objectives, features, and advantages of this application more obvious and easier to understand, this application will be further described in detail with reference to the accompanying drawings and specific implementations.

### Embodiment 1

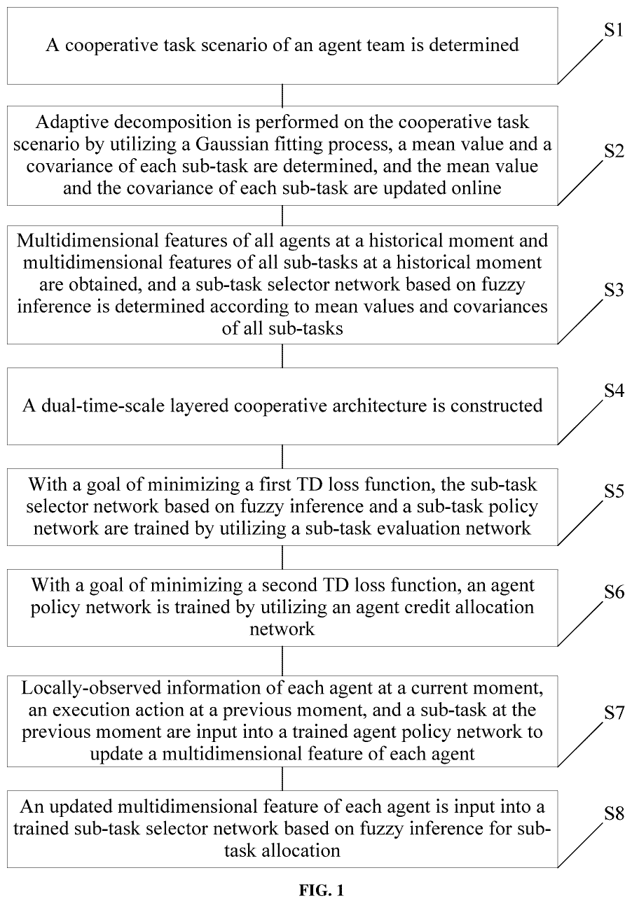

In this embodiment, a multi-agent task allocation method based on fuzzy inference is provided. As shown in FIG. 1, the multi-agent task allocation method based on fuzzy inference specifically includes the following steps.

Step S1, a cooperative task scenario of an agent team is determined, where the agent team includes a plurality of agents, and a plurality of sub-tasks are assigned in the cooperative task scenario.

In an example, the agent team includes N unmanned surface vehicle teams, and a cooperative task scenario of the agent team is a circular domain with a guard radius of 1 km in a 7.5 km×7.5 km sea area. In the cooperative task scenario, an unmanned surface vehicle can perform δₖ sub-tasks such as domain searching, task point exploring, and strange ship tracking.

Step S2, adaptive decomposition is performed on the cooperative task scenario by utilizing a Gaussian fitting process, a mean value and a covariance of each sub-task are determined, and the mean value and the covariance of each sub-task are updated online.

In this embodiment, the step S2 specifically includes the following steps.

Step S21, a group of supervised offline data set is obtained, where the offline data set includes a historical trajectory of an agent for executing each sub-task, and an environment reward of each agent.

Step S22, a reward function f(x) of each sub-task is obtained through Gaussian fitting by using the historical trajectory of the agent for executing each sub-task as an input and using the environment reward of each agent as an output.

Step S23, a mean value σ and a covariance l of each sub-task are determined based on a reward function f(x), where an expression formula of the reward function f(x) is:

$$f ( x ) = {{k}^{T} ( K + {μ}^{2} I )}^{- 1} y ,$$

where

k is a core vector, K is a core matrix, μ² is a variance of noise, I is a unit matrix, and the core vector k satisfies:

$$k = [ {K}_{SE} ( {x}_{1} , {x}_{2} ) , … , {K}_{SE} ( {x}_{i} , {x}_{j} ) ; and$$

$${K}_{SE} ( {x}_{i} , {x}_{j} ) = {σ}^{2} exp ( - \frac{{‖ {x}_{i} - {x}_{j} ‖}_{2}^{2}}{2 {l}^{2}} ) ,$$

where

K_{SE}(·) is a Gaussian core function, and xᵢ and xⱼ are different input data (which belong to the offline data set).

Step S24, the mean value and the covariance of each sub-task are updated online by utilizing a negative log likelihood function.

Step S3, multidimensional features of all agents at a historical moment and multidimensional features of all sub-tasks at the historical moment are obtained, and a sub-task selector network based on fuzzy inference is determined according to mean values and covariances of all sub-tasks, where the multidimensional feature includes an action sequence, a historical trajectory, and a contribution value.

In the multidimensional feature of the agent, the action sequence represents execution actions of the agent at different moments, the historical trajectory represents a motion change trend of the agent, and the contribution value represents contribution of the execution action of the agent on the cooperative task scenario. There may be more than one agent for executing a sub-task, a multidimensional feature of the corresponding sub-task is obtained by averaging multidimensional features of a plurality of agents.

In an example, a multidimensional feature of an agent a satisfies:

$${x}^{a} = {[ {x}_{i}^{a} ]}_{i = 1}^{3} = [ {e}^{a} , {τ}^{a} , {q}^{a} ] ,$$

where x^{a} is the multidimensional feature of the an agent a,

$${x}_{i}^{a}$$

is a i^{th} feature in x^{a}, e^{a} is an action sequence, τ^{a} is a historical trajectory, and q^{a} is a contribution value.

In this embodiment, the step S3 specifically includes the following steps.

S31, a base rule of a TSK (Takagi-Sugeno-Kang) form is defined.

In an example, if

$${x}_{1}^{a}$$

belongs to a fuzzy set

$${χ}_{1}^{l} , {x}_{2}^{a}$$

belongs to a fuzzy set

$${χ}_{2}^{l} , and {x}_{3}^{a}$$

belongs to a fuzzy set

$${χ}_{3}^{l} .$$

In this case, a corresponding rule output is f₁=[0, . . . ,0,1,0, . . . ,0].

Step S32, under the base rule, each sub-task is taken as a fuzzy set, and a Gaussian membership function under each fuzzy set is constructed based on the multidimensional feature of each agent at the historical moment, the multidimensional feature of each sub-task at the historical moment, and the mean value and the covariance of each sub-task.

The Gaussian membership function is:

$${μ}_{{χ}_{ϕ}^{l}} ( {x}^{a} ) = {σ}^{2} exp ( - \frac{{‖ {x}^{ϕ} - {x}^{a} ‖}_{2}^{2}}{2 {l}^{2}} ) ,$$

where
x^{ϕ} is a multidimensional feature of a sub-task ϕ,

$${χ}_{ϕ}^{l}$$

is a fuzzy but corresponding to the sub-task ϕ, and μ_{χ}_{_{ϕ}}_{^{l}}(x^{a}) is a Gaussian membership of x^{a}.

Step S33, the base rule is adjusted according to the Gaussian membership functions under all fuzzy sets to obtain a fuzzy inference rule for the cooperative task scenario.

Specifically, under the base rule of TSK form, a size of a Gaussian membership corresponding to each fuzzy set can be compared to determine values at different locations in a rule output fₗ, so as to obtain a complete fuzzy inference rule; and a quantity of finally obtained fuzzy inference rules is consistent with a quantity of fuzzy sets.

Step S34, the fuzzy inference rule is applied to the sub-task selector network to obtain the sub-task selector network based on fuzzy inference, where the sub-task selector network includes a fully-connected layer, a fuzzy inference layer, and a normalization layer that are sequentially connected.

The sub-task selector network based on fuzzy inference can be configured to implement automatic allocation of sub-tasks of agents. Firing strength of each fuzzy inference rule is calculated based on the multidimensional feature of the agent and the corresponding Gaussian membership, specifically as follows:

$${η}_{l} ( {x}^{a} ) = {\prod }_{i = 1}^{3} {μ}_{{χ}_{ϕ}^{l}} ( {x}_{i}^{a} ) ,$$

where

ηₗ(x^{a}) is a Gaussian membership of the agent a of the sub-task ϕ under a fuzzy inference rule l.

Then, defuzzification is performed on a fuzzy inference result through a weighted average calculation manner to determine a sub-task result selected by the agent a, specifically as follows:

$${ϕ}^{a} = \frac{{\sum }_{l = 1}^{m} {η}_{l} ( {x}^{a} ) \cdot {f}_{l}}{{\sum }_{l = 1}^{m} {η}_{l} ( {x}^{a} )} ,$$

where

ϕ^{a} is a sub-task selected by the agent a, and m is a quantity of fuzzy inference rules.

Step S4, a dual-time-scale layered cooperative architecture is constructed.

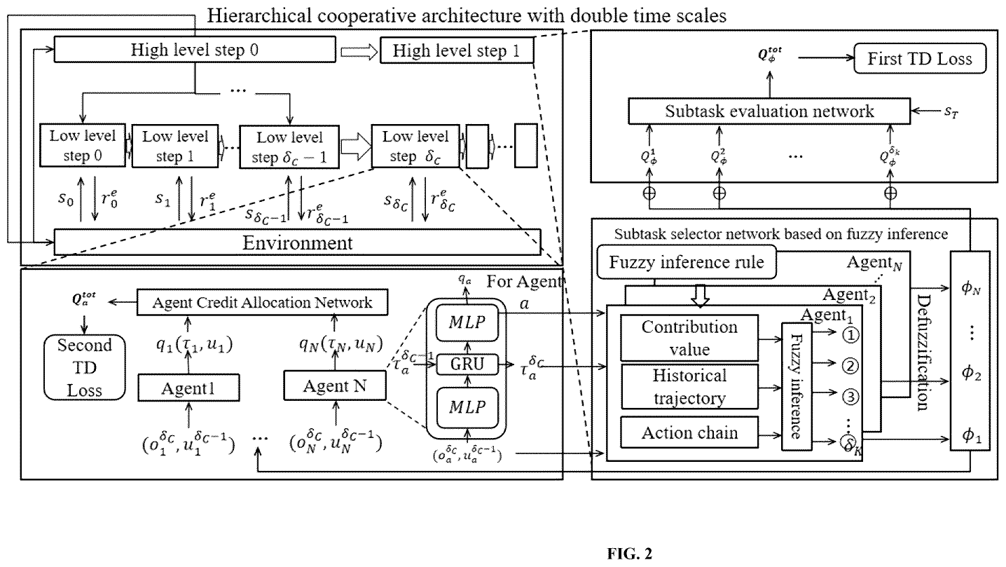

As shown in FIG. 2, the dual-time-scale layered cooperative architecture is divided into two layers, namely a top layer and a bottom layer. A dual-time scale means that a top-layer time step is T, and a bottom-layer time step is t, the two time steps satisfy: T<t, and one T corresponds to δ_{c} ts. The top layer of the layered cooperative architecture includes the sub-task selector network based on fuzzy inference, a sub-task evaluation network, and a plurality of sub-task policy networks. The bottom layer of the layered cooperative architecture includes an agent credit allocation network and an agent policy network.

Specifically, the sub-task evaluation network is configured to: evaluate an execution progress of each sub-task and determine a total task value

$${Q}_{ϕ}^{tot} ,$$

where the total task value represents an execution progress in the cooperative task scenario. The sub-task policy network is configured to determine a multidimensional feature of a sub-task. The agent credit allocation network is configured to: evaluate contribution of each agent on the agent team, and determine a team value

$${Q}_{a}^{tot} .$$

The team value represents overall efficiency of the agent team in the cooperative task scenario. The agent policy network is configured to determine a multidimensional feature and an action value of the agent (for example, the agent has three actions of going straight, turning left and turning right, and the action values indicate values of performing the three actions).

In this embodiment, the sub-task policy network includes a fully-connected layer, a recurrent layer, and a fully-connected layer that are sequentially connected. The sub-task evaluation network is a hybrid network in a QMIX algorithm. The agent policy network and the agent credit allocation network are respectively a policy network and a hybrid network in a VDN algorithm.

As a preferably implementation, the dual-time-scale layered cooperative architecture further includes a top-layer experience pool and a bottom-layer experience pool.

The top-layer experience tool is configured to store a first data tuple at different moments, where the first data tuple includes at least: global environment information, locally-observed information of all agents, an ID of a sub-task executed by all agents, a multi-step accumulative reward (including an intrinsic reward and an accumulative environment reward) of all sub-tasks, and the like. The global environment information includes: types, locations, and speeds of all agents, a type and a location of an environment entity (referred to as the cooperative task scenario), and the like. The locally-observed information includes a location and a speed of the current agent, a location and a speed of another agent within an observation range of the current agent, basic information (a speed and a location) of another entity (an obstacle rather than the agent) within the observation range of the current agent, and the like.

The bottom-layer experience tool is configured to store a second data tuple at different moments, where the second data tuple includes at least locally-observed information of all agents, an execution action, and an environment reward (artificially given).

Step S5, with a goal of minimizing a first TD loss function, the sub-task selector network based on fuzzy inference and the sub-task policy network are trained by utilizing the sub-task evaluation network, where an intrinsic reward r^{int} of the sub-task and an accumulative environment reward

$${\sum }_{t = 1}^{{δ}_{c}} {r}_{t}^{e}$$

are added into the first ID loss function.

The first TD loss function is:

$${ℒ}_{ϕ} ( {θ}_{ϕ} , {ξ}_{ϕ} , {ε}_{ϕ} ) = {E}_{{𝒟}^{h}} [ {( {R}_{T} + γ max {\overline{Q}}_{ϕ}^{tot} ( {s}_{T + 1} , {ϕ}_{T + 1} ) - {Q}_{ϕ}^{tot} ( {s}_{T} , {ϕ}_{T} ) )}^{2} ] , where$$

$${R}_{T} = {r}^{int} + {\sum }_{t = 1}^{{δ}_{c}} {r}_{t}^{e} ,$$

where

[symbol] _{ϕ}(·) is a first TD loss, θ_{ϕ} is a parameter of the sub-task policy network, ξ_{ϕ} is a parameter of the sub-task evaluation network, ε_{ϕ} is a parameter of the sub-task selector network based on fuzzy inference, [symbol] is an expected value of a top-layer accumulative reward of the layered cooperative architecture, R_{T} is a multi-step accumulative reward of the sub-task, γ is a discount factor,

$${\overline{Q}}_{ϕ}^{tot}$$

is a target total task value of the sub-task evaluation network, s_{T} is global environment information at a moment T, ϕ_{T} are sub-tasks executed by all agents at the moment T,

$${r}_{t}^{e}$$

is an environment reward at a moment t, and δ_{c} is a sub-task selection frequency.

Step S6, with a goal of minimizing a second TD loss function, the agent policy network is trained by utilizing the agent credit allocation network.

The second loss function is given by:

$${ℒ}_{a} ( {θ}_{a} , {ξ}_{a} ) = {E}_{{𝒟}^{l}} [ {( {r}_{t}^{e} + γ max {\overline{Q}}_{a}^{tot} ( {s}_{t + 1} , {u}_{t + 1} ) - {Q}_{a}^{tot} ( {s}_{t} , {u}_{t} ) )}^{2} ] ,$$

where

[symbol] ₐ(·) is a second TD loss, θₐ is a parameter of the agent policy network, ξₐ is a parameter of the agent credit allocation network, [symbol] is an expected value of a bottom-layer accumulative reward of the layered cooperative architecture,

$${\overline{Q}}_{a}^{tot}$$

is a target team value of the agent credit allocation network, sₜ is locally-observed information of all agents at a moment t, sₜ satisfies

$${s}_{t} = [ {o}_{t}^{1} , … , {o}_{t}^{N} ] , {o}_{t}^{N}$$

is locally-observed information of an agent N at the moment t, uₜ is an execution action of all agents at the moment t, uₜ satisfies

$${u}_{t} = [ {u}_{t}^{1} , … , {u}_{t}^{N} ] , and {u}_{t}^{N}$$

is an execution action of the agent N at the moment t.

Step S7, locally-observed information of each agent at a current moment, an execution action at a previous moment and a sub-task at the previous moment are input into a trained agent policy network to update a multidimensional feature of each agent.

Step S8, an updated multidimensional feature of each agent is input into a trained sub-task selector network based on fuzzy inference for sub-task allocation.

In this embodiment, each agent is configured to execute an action under the trained agent policy network according to an allocated sub-task. An action value of the agent can be determined by the agent policy network, and therefore, the sub-task obtained through allocation in step S8 is input into the trained agent policy network to evaluate values of all actions under the sub-task, and an action with a highest value is selected to execute.

In conclusion, under the dual-time-scale layered cooperative architecture, an allocation process of the sub-task and a policy learning process are separately trained to implement multi-agent cooperative policy learning. This improves a sub-task allocation accuracy rate of the plurality of agents under a complex task scenario, and improves completion efficiency of a cooperative task. In addition, it should be noted that, the steps S1 to S6 only need to be executed during first-time training, and the steps S7 to S9 only need to be executed in an actual subsequent application process.

### Embodiment 2

The following specifically provides an actual application scenario of a multi-agent task allocation method based on fuzzy inference in this embodiment.

In a first step, a domain cooperative defense task scenario with a plurality of unmanned surface vehicles is initialized.

(1) It is determined that a quantity of our unmanned surface vehicles is N, and a sensing range of an unmanned surface vehicle sensor is Cₐ={(x−xᵢ)²+(y−yᵢ)²=d²|A(xᵢ,yᵢ),d}; A(·) is a circle center of the unmanned surface vehicle, (xᵢ, yᵢ) are coordinates of the unmanned surface vehicle, and d is a sensing radius of the unmanned surface vehicle sensor.

In addition, a location

$${\{ {P}_{i} \vert ( {x}_{i} , {y}_{i} ) \}}_{i = 1}^{m}$$

and a domain range C={(x−a)²+(y−b)²=r²|O(a,b), r} of a to-be-explored task point are initialized; m is a quantity of task points, O(·) is a circle center of the task point, (a, b) are coordinates of the task point, and r is a radius of an explored task point.

(2) Within a sensing range of our unmanned surface vehicle, it is obtained that a quantity of opponent unmanned surface vehicles is Nₑ, and a tracking quantity attribute required by the opponent unmanned surface vehicle is eⱼ∈I={1,2}. The attribute indicates that the opponent unmanned surface vehicle needs to be tracked by our one or two unmanned surface vehicles.

(3) Three sub-tasks which are respectively a domain searching task, a task point exploring task and a strange ship tracking task are initialized according to a type of the domain cooperative defense task scenario.

In a second step, a goal of the domain cooperative defense task is clear: on the premise of avoiding a collision, a red party and a blue party are respectively a defense party and an attack party. A goal of our party is that a central circular domain area C is defended by five red unmanned surface vehicles to maximize a searching vicinity range and sense an unmanned surface vehicle that appears the first time, so as to avoid attack by a peripheral opponent unmanned surface vehicle within a domain range and perform proximity exploring on a task point appearing in the scenario; a proper sub-task is selected in a fuzzy logic inference process by our unmanned surface vehicle to execute according to an action sequence, a historical trajectory, a contribution value, and global environment information; a sub-task selection frequency is pre-defined according to a complexity level of the domain cooperative defense task, a dual-layer experience pool is constructed and updated, and information such as local observation, an execution action, an environment rewind, and sub-task selection of the unmanned surface vehicle in the task execution process is stored.

(1) A completely-cooperative multi-unmanned-surface-vehicle task can be described as a locally-observable Markov process, and a real state <S, U, P, r, O> of an environment is described by using a tuple, where S is state space, U is action space, P is a state transition function, r is a same reward function shared by all unmanned surface vehicles, and O is local observation space of the unmanned surface vehicle.

(2) The bottom-layer experience pool and the top-layer experience pool are constructed and initialized according to the dual-time-scale layered cooperative architecture. In addition, a quantity of sub-tasks and a sub-task selection frequency further need to be initialized.

In a third step, a reward function of a sub-task is determined, and a type and a feature of the sub-task are determined.

(1) Based on a pre-defined sub-task type (domain searching, task point exploring, and strange ship tracking), Gaussian fitting is performed on the sub-task through a group of supervised offline data set.

(2) For any sub-task, a reward function of each sub-task is fitted by using a historical trajectory of an unmanned surface vehicle that selects the sub-task as an input and using an environment reward of the unmanned surface vehicle as an output, where the reward function satisfies Gaussian distribution.

(3) Two hyper-parameters, namely, a mean value and a covariance are updated online by using a negative log likelihood function.

In a fourth step, a fuzzy inference rule base for sub-task selection is constructed, a multidimensional feature of the unmanned surface vehicle is determined, and a multidimensional feature of each sub-task is correspondingly obtained according to the multidimensional feature of the unmanned surface vehicle. Each sub-task is considered as a fuzzy set, and a Gaussian membership function under each fuzzy set (namely, the sub-task) is constructed based on the online-updated hyper-parameters in the Gaussian fitting process of the reward function, to obtain a fuzzy inference rule for searching, exploring, and tracking in the sub-task scenario.

(1) Each sub-task is that for different fuzzy sets for fuzzy inference, the Gaussian membership function under each fuzzy set is obtained according to the Gaussian fitting process of the sub-task.

(2) A fuzzy inference rule of a TSK form is constructed by combining the multidimensional feature of the unmanned surface vehicle and the multidimensional feature of the sub-task.

In a fifth step, a sub-task selector network based on fuzzy inference is designed, where the sub-task selector network is configured to allocate a sub-task that is most suitable for a current state to each unmanned surface vehicle for execution; and a sub-task with a highest matching degree with a current responsibility of each unmanned surface vehicle is output though real-time inference of the fuzzy inference rule base.

(1) Firing strength of each fuzzy rule is calculated through the multidimensional feature of the unmanned surface vehicle and the membership function of the fuzzy set.

(2) A fuzzy inference result is defuzzied through a weighted average calculation manner.

In a sixth step, under a dynamic environment and task need change condition, a value of the sub-task is evaluated based on a sub-task evaluation network. The sub-task evaluation network is configured to: evaluate a degree of completion of each sub-task and implement balanced sub-task allocation according to global state information.

(1) One sub-task policy network is maintained for each sub-task, and a reward of the sub-task is defined as a multi-step accumulative sum of an intrinsic reward and an environment reward.

(2) For one sub-task, action values adopted by an unmanned surface vehicle that executes the sub-task are accumulated to obtain a value of the sub-task, the value of the sub-task is input into the sub-task evaluation network as a local value to obtain a total task value

$${Q}_{ϕ}^{tot} ,$$

and the sub-task evaluation network, the sub-task selector network, and a plurality of sub-task policy networks are updated by minimizing a first TD loss function.

In a seventh step, dynamic sub-task allocation is performed at a top layer according to the dual-time-scale layered cooperative architecture to obtain a sub-task allocation result, the sub-task allocation result is output to each unmanned surface vehicle at a bottom layer, and the unmanned surface vehicle at the bottom layer is configured to, according to a current allocated sub-task, execute a task under a policy network of the sub-task.

(1) At the top layer, the sub-task selector network based on fuzzy inference is combined with the multidimensional feature of the unmanned surface vehicle, a sub-task of the unmanned surface vehicle is inferred and output through a fuzzy rule, and a sub-task value is evaluated based on a hybrid network in a QMIX algorithm.

(2) At the bottom layer, locally-observed information of the unmanned surface vehicle at a current moment, an execution action at a previous moment, and the selected sub-task are input into an unmanned surface vehicle policy network for policy learning to obtain action values of the unmanned surface vehicle, the action values are input into a hybrid network in a VDN algorithm as local values to obtain a team value

$${Q}_{a}^{tot} ,$$

and an unmanned surface vehicle credit allocation network and the unmanned surface vehicle policy network are updated by minimizing a second TD loss function.

(3) Networks at the top layer and the bottom layer of the dual-time-scale layered cooperative architecture are optimized based on the first TD loss function and the second TD loss function to determine a loss function for layered learning:

$$ℒ = {ℒ}_{ϕ} ( {θ}_{ϕ} , {ξ}_{ϕ} , {ε}_{ϕ} ) + {ℒ}_{a} ( {θ}_{a} , {ξ}_{a} ) ,$$

[symbol] is a total loss of the dual-time-scale layered cooperative architecture.

In an eighth step, an experimental description and an experimental result are provided.

An experimental environment in this embodiment includes two parts: “a multi-unmanned-surface-vehicle domain cooperative defense task” scenario constructed based on unity, and a “home resource collection in a reference multi-agent experimental environment MPE” scenario. In the multi-unmanned-surface-vehicle domain cooperative defense task, three sub-tasks are predefined, including a domain cooperative searching task, a task point exploring task, and a strange ship tracking task. On the premise of avoiding a collision between unmanned surface vehicles, the three sub-tasks are cooperatively selected, there are five unmanned surface vehicles in a simulation environment, there are three task points, actions are set as five discrete “direction-speed” selections, there are four strange chips, and there is one or two ships that need to be tracked. MPE is a cooperative multi-agent reinforcement learning environment designed under a local observation condition, and the home resource collection scenario is selected as a reference experimental environment, to achieve a goal of collecting, in a sub-task of defending an intruder from a home, resources of different colors near the home according to collection capabilities of different agents on resources of various types.

(1) The following specifically provides the experimental result in the multi-unmanned-surface-vehicle domain cooperative defense task scenario.

The method is trained under settings of five unmanned surface vehicles, three task points and four strange ships. In the training process, initial locations of the unmanned surface vehicles and the target points are random, a quantity of training rounds is 30500000, and a maximum step number that is interacted with the environment each round is 2000.

The experimental effect is a team reward. As for the team reward, the bigger the better in single-round experiment. According to the method in this application, in task settings in which there are five unmanned surface vehicles, a corresponding sub-task is selected for the sub-task selector network based on fuzzy inference according to an action sequence, a historical trajectory, and a contribution value of each unmanned surface vehicle. In consideration of an action sequence executed by the unmanned surface vehicle within a period of time, if a sub-task of a specific type is continuously executed by the unmanned surface vehicle, a task of the same type needs to be continuously executed in the current environment. For example, if the domain cooperative searching task is always executed by the unmanned surface vehicle recently, the task needs to be continuously executed to ensure searching coverage. In addition, a historical trajectory of the current unmanned surface vehicle and a historical trajectory of another unmanned surface vehicle are analyzed to learn a behavior mode and a task execution condition in the past, so as to make a decision by utilizing the prior experience. Finally, in the domain cooperative searching task, a contribution value is evaluated according to searching efficiency and a coverage range of the unmanned surface vehicle. In the task point exploring task, a contribution value is evaluated according to positioning precision and exploring efficiency of the unmanned surface vehicle. In the strange ship tracking task, a contribution value is evaluated according to a target tracking capability of the unmanned surface vehicle. In this way, the unmanned surface vehicles can be allocated by the sub-task selector network in an optimal manner to execute different sub-tasks, to maximize overall task efficiency.

(2) The following specifically provides the experimental result in the “home resource collection in the reference multi-agent experimental environment MPE” scenario.

Table 1 shows comparative results (the result values are an average team reward) between the method in this application and each reference method in resource collection tasks with different quantities of agents. The method in this application and the reference method are separately trained in scenarios with n=4, n=5 and being a random number (from 2 to 6), are trained for four times in each scenario, and are separately inferred for 50 rounds for comparison with an average reward obtained through calculation. An existing reference method for comparison includes: regularized softmax deep multi-agent q-learning (RES), monotonic value function factorisation for deep multi-agent reinforcement learning (QMIX), and learning to factorize with transformation for cooperative multi-agent reinforcement learning (QTRAN). In addition, in the method in this application, different sub-task quantities (m=3, 4, and 5) are separately set for contrast experiment of hyper-parameters.

TABLE 1
Comparative result table of different methods in
resource collection tasks with agent quantities

| | |
|---|---|
| Method | Quantity of agents |

| name | n = 4 | n = 5 | Random |
|---|---|---|---|
| RES | 95.8 ± 1.5% | 102.6 ± 1.3% | 76.9 ± 0.2% |
| QMIX | 90.3 ± 12.9% | 86.4 ± 20.4% | 65.3 ± 19.8% |
| QTRAN | 94.7 ± 8.6% | 104.5 ± 5.9% | 69.0 ± 6.4% |
| This application | 156.2 ± 1.2% | 167.2 ± 1.9% | 129.5 ± 2.4% |
| (m = 3) | | | |
| This application | 164.9 ± 0.4% | 168.3 ± 0.8% | 122.7 ± 1.1% |
| (m = 4) | | | |
| This application | 135.7 ± 1.7% | 139.8 ± 1.3% | 109.6 ± 1.6% |
| (m = 5) | | | |

### Embodiment 3

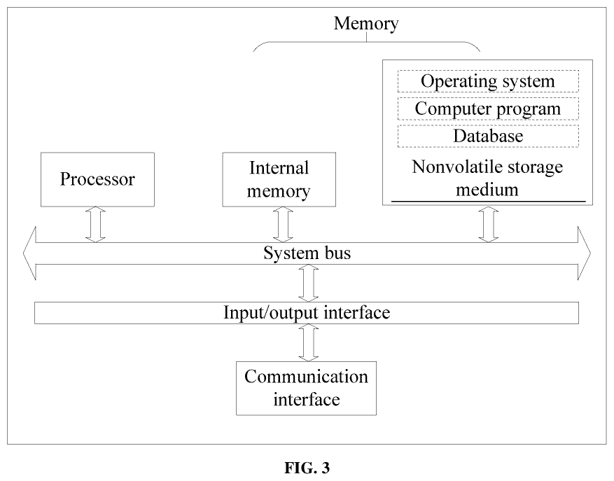

In this embodiment, a computer system is provided. The computer system may be a server or a terminal, and an internal structure thereof may be as shown in FIG. 3. The computer system includes a processor, a memory, an input/output (I/O) interface, and a communication interface. The processor, the memory, and the I/O interface are connected through a system bus. The communication interface is connected to the system bus through the I/O interface. The processor of the computer system is configured to provide computing and control capabilities. The memory of the computer system includes a nonvolatile storage medium and an internal memory. The nonvolatile storage medium stores an operating system, a computer program, and a database. The internal memory provides an environment for operation of the operating system and the computer program in the nonvolatile storage medium. A database of the computer system is configured to store video tag processed data. The I/O interface of the computer system is configured to exchange information between the processor and an external device. The communication interface of the computer system is configured to communicate with an external terminal through a network. When the computer program is executed by the processor, a multi-agent task allocation method based on fuzzy inference is implemented.

Those skilled in the art may understand that the structure shown in FIG. 3 is only a block diagram of a part of the structure related to the solution of this application and does not constitute a limitation on a computer device to which the solution of the present disclosure is applied. Specifically, the computer device may include more or less components than those shown in the figure, or combine some components, or have different component arrangements.

### Embodiment 4

In this embodiment, a computer-readable storage medium is provided. The computer-readable storage medium stores a computer program, and when the computer program is executed by a processor, the steps of the above method embodiment are implemented.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a storage, a database, or other media used in the embodiments of this application may include a non-volatile and/or volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of this application may include at least one of a relational database and a non-relational database. The non-relational database may include a distributed database based on a blockchain, but is not limited thereto. The processor in the embodiments of this application may be a general processor, a central processor, a graphics processor, a digital signal processor, a programmable logic device, and a data processing logic device based on quantum computing, but is not limited thereto.

Each embodiment in the description is described in a progressive mode, each embodiment focuses on differences from other embodiments, and references can be made to each other for the same and similar parts between embodiments.

Several examples are used herein for illustration of the principles and implementations of this application. The description of the foregoing examples is used to help illustrate the method of this application and the core principles thereof. In addition, those of ordinary skill in the art can make various modifications in terms of specific implementations and scope of application in accordance with the teachings of this application. In conclusion, the content of the present specification shall not be construed as a limitation to this application.

What is claimed is:

1. A multi-agent task allocation method based on fuzzy inference, comprising the following steps:
determining a cooperative task scenario of an agent team, wherein the agent team comprises a plurality of agents, and a plurality of sub-tasks are assigned in the cooperative task scenario;
performing adaptive decomposition on the cooperative task scenario by utilizing a Gaussian fitting process, determining a mean value and a covariance of each sub-task, and updating the mean value and the covariance of each sub-task online;
obtaining multidimensional features of all agents at a historical moment and multi dimensional features of all sub-tasks at the historical moment, and determining a sub-task selector network based on fuzzy inference according to mean values and covariances of all sub-tasks, wherein the multidimensional feature comprises an action sequence, a historical trajectory, and a contribution value;
constructing a dual-time-scale layered cooperative architecture, wherein a top layer of the layered cooperative architecture comprises the sub-task selector network based on fuzzy inference, a sub-task evaluation network, and a plurality of sub-task policy networks; a bottom layer of the layered cooperative architecture comprises an agent credit allocation network and an agent policy network; the sub-task evaluation network is configured to: evaluate an execution progress of each sub-task and determine a total task value; the total task value represents an execution progress in the cooperative task scenario, and the sub-task policy network is configured to determine a multidimensional feature of a sub-task; the agent credit allocation network is configured to: evaluate contribution of each agent on the agent team, and determine a team value; the team value represents overall efficiency of the agent team in the cooperative task scenario, and the agent policy network is configured to determine a multidimensional feature and an action value of the agent;
with a goal of minimizing a first Temporal Difference (TD) loss function, training the sub-task selector network based on fuzzy inference and the sub-task policy network by utilizing the sub-task evaluation network, wherein an intrinsic reward of the sub-task and an accumulative environment reward are added into the first TD loss function;
with a goal of minimizing a second TD loss function, training the agent policy network by utilizing the agent credit allocation network;
inputting locally-observed information of each agent at a current moment, an execution action at a previous moment, and a sub-task at the previous moment into a trained agent policy network to update a multidimensional feature of each agent, wherein the locally-observed information comprises at least a location and a speed of a current agent, and a location and a speed of another agent within an observation range of the current agent; and
inputting an updated multidimensional feature of each agent into a trained sub-task selector network based on fuzzy inference for sub-task allocation.

2. The multi-agent task allocation method based on fuzzy inference according to claim 1, wherein the performing adaptive decomposition on the cooperative task scenario by utilizing a Gaussian fitting process, determining a mean value and a covariance of each sub-task, and updating the mean value and the covariance of each sub-task online specifically comprises:
obtaining a group of supervised offline data set, wherein the offline data set comprises a historical trajectory of an agent for executing each sub-task, and an environment reward of each agent;
obtaining a reward function of each sub-task through Gaussian fitting by using the historical trajectory of the agent for executing each sub-task as an input and using the environment reward of each agent as an output;
determining the mean value and the covariance of each sub-task based on the reward function; and
updating the mean value and the covariance of each sub-task online by utilizing a negative log likelihood function.

3. The multi-agent task allocation method based on fuzzy inference according to claim 1, wherein the obtaining multidimensional features of all agents at a historical moment and multidimensional features of all sub-tasks at the historical moment, and determining a sub-task selector network based on fuzzy inference according to mean values and covariances of all sub-tasks specifically comprises:
defining a base rule of a Takagi-Sugeno-Kang (TSK) form;
under the base rule, taking each sub-task as a fuzzy set, and constructing a Gaussian membership function under each fuzzy set based on the multidimensional feature of each agent at the historical moment, the multidimensional feature of each sub-task at the historical moment, and the mean value and the covariance of each sub-task;
adjusting the base rule according to the Gaussian membership functions under all fuzzy sets to obtain a fuzzy inference rule for the cooperative task scenario; and
applying the fuzzy inference rule to the sub-task selector network to obtain the sub-task selector network based on fuzzy inference, wherein the sub-task selector network comprises a fully-connected layer, a fuzzy inference layer, and a normalization layer that are sequentially connected.

4. The multi-agent task allocation method based on fuzzy inference according to claim 1, wherein the first TD loss function is:
$${ℒ}_{ϕ} ( {θ}_{ϕ} , {ξ}_{ϕ} , {ε}_{ϕ} ) = {E}_{{𝒟}^{h}} [ {( {R}_{T} + γ max {\overline{Q}}_{ϕ}^{tot} ( {s}_{T + 1} , {ϕ}_{T + 1} ) - {Q}_{ϕ}^{tot} ( {s}_{T} , {ϕ}_{T} ) )}^{2} ] ; and$$
$${R}_{T} = {r}^{int} + {\sum }_{t = 1}^{{δ}_{c}} {r}_{t}^{e} ,$$
wherein [symbol]
_{ϕ}(·) is a first TD loss, θ_{ϕ} is a parameter of the sub-task policy network, ξ_{ϕ} is a parameter of the sub-task evaluation network, ε_{ϕ} is a parameter of the sub-task selector network based on fuzzy inference, [symbol] is an expected value of a top-layer accumulative reward of the layered cooperative architecture, R_{T} is a multi-step accumulative reward of the sub-task, γ is a discount factor,
$${\overline{Q}}_{ϕ}^{tot}$$
is a target total task value of the sub-task evaluation network,
$${Q}_{ϕ}^{tot}$$
is an actual total task value of the sub-task evaluation network, s_{T} is global environment information at a moment T, ϕ_{T} is a sub-task executed by all agents at the moment T, r^{int} is an intrinsic reward of the sub-task,
$${r}_{t}^{e}$$
is an environment reward at a moment t, and δ_{c} is a sub-task selection frequency, wherein T>t.

5. The multi-agent task allocation method based on fuzzy inference according to claim 1, wherein the second TD loss function is:
$${ℒ}_{a} ( {θ}_{a} , {ξ}_{a} ) = {E}_{{𝒟}^{l}} [ {( {r}_{t}^{e} + γ max {\overline{Q}}_{a}^{tot} ( {s}_{t + 1} , {u}_{t + 1} ) - {Q}_{a}^{tot} ( {s}_{t} , {u}_{t} ) )}^{2} ] ,$$
wherein [symbol]
ₐ(·) is a second TD loss, θₐ is a parameter of the agent policy network, ξₐ is a parameter of the agent credit allocation network, [symbol] is an expected value of a bottom-layer accumulative reward of the layered cooperative architecture,
$${r}_{t}^{e}$$
is an environment reward at a moment t, γ is a discount factor,
$${\overline{Q}}_{a}^{tot}$$
is a target team value of the agent credit allocation network,
$${Q}_{a}^{tot}$$
is an actual team value of the agent credit allocation network, sₜ is locally-observed information of all agents at the moment t, and uₜ is an execution action of all agents at the moment 1.

6. The multi-agent task allocation method based on fuzzy inference according to claim 1, wherein the sub-task policy network comprises a fully-connected layer, a recurrent layer, and a fully-connected layer that are sequentially connected, and the sub-task evaluation network is a hybrid network in a QMIX algorithm.

7. The multi-agent task allocation method based on fuzzy inference according to claim 1, wherein the agent policy network and the agent credit allocation network are respectively a policy network and a hybrid network in a Value-Decomposition Networks (VDN) algorithm.

8. The multi-agent task allocation method based on fuzzy inference according to claim 1, wherein the layered cooperative architecture further comprises a top-layer experience pool and a bottom-layer experience pool, wherein
the top-layer experience tool is configured to store a first data tuple at different moments, the first data tuple comprises at least: global environment information, an identity (ID) of a sub-task executed by all agents, and a multi-step accumulative reward of all sub-tasks; the global environment information comprises at least: types, locations, and speeds of all agents, and a type and a location of an environment entity; and the multi-step accumulative reward comprises the intrinsic reward of the sub-task and the accumulative environment reward; and
the bottom-layer experience tool is configured to store a second data tuple at different moments, wherein the second data tuple comprises at least locally-observed information of each agent, an execution action, and an environment reward.
